(19) United States
(12) Patent Application Publication
(10) Pub. No.: US 2014/0201413 A1
(43) Pub. Date: Jul. 17, 2014

(54) Method and Apparatus for Backplane Support of 100/1000 Ethernet

(71) Applicant: BROADCOM CORPORATION, Irvine, CA (US)

(72) Inventor: Stephen Bailey, Palo Alto, CA (US)

(73) Assignee: Broadcom Corporation, Irvine, CA (US)

(21) Appl. No.: 13/751,230

(22) Filed: Jan. 28, 2013

Related U.S. Application Data
(60) Provisional application No. 61/751,603, filed on Jan. 11, 2013.

(51) Int. Cl. G06F 13/40

(52) U.S. Cl. CPC G06F 13/409
USPC 710/301

(57) ABSTRACT

A method and apparatus for backplane support of 100/1000 Ethernet. A communication card for use in a chassis system is provided that includes a 100BASE-TX physical layer device component, a 1000BASE-KX physical layer device component, and a backplane connector, which is configured for enabling communication by the communication card over a backplane of the chassis system. The communication card also includes a selection module (e.g., a multiplexer) that is configured to selectively couple one of the 100BASE-TX physical layer device component and the 1000BASE-KX physical layer device component to the backplane connector, wherein the selective coupling enables a selected one of the 100BASE-TX physical layer device component and the 1000BASE-KX physical layer device component to communicate with a second communication card via the backplane of the chassis system.

This application claims priority to provisional application no. 61/751,603, filed Jan. 11, 2013, which is incorporated herein by reference in its entirety.

### BACKGROUND

1. Field of the Invention

The present invention relates generally to networking and, more particularly, to a method and apparatus for backplane support of 100/1000 Ethernet.

2. Introduction

Data communication networks continue to expand in reach and capacity. The continual evolution of data communication networks presents continuing challenges in integrating new technologies alongside legacy technologies. Maximizing the support of existing data networking infrastructure is an important consideration in maximizing the return on previous infrastructure investments.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of a backplane communication card that includes 100/1000 Ethernet support.

FIG. 2 illustrates an example of a 100/1000 backplane communication card communicating with a 100BASE-TX communication card.

FIG. 3 illustrates an example of a 100/1000 backplane communication card communicating with a 1000BASE-KX communication card.

FIG. 4 illustrates a flowchart of a process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Enterprise networks such as that included within a data center rely on vast amounts of rack-based switches and servers. As the lifespan of data center can extend upwards of 10-15 years, the support of existing network components within the data center is an important factor in maximizing the return on investment.

In accordance with the present invention, a communication card for use in a chassis system is provided that includes a 100BASE-TX physical layer device component, a 1000BASE-KX physical layer device component, and a backplane connector, which is configured for enabling communication by the communication card over a backplane of the chassis system. The communication card also includes a selection module (e.g., a multiplexer) that is configured to selectively couple one of the 100BASE-TX physical layer device component and the 1000BASE-KX physical layer device component to the backplane connector, wherein the selective coupling enables a selected one of the 100BASE-TX physical layer device component and the 1000BASE-KX physical layer device component to communicate with a second communication card via the backplane of the chassis system. The selective coupling of one of the 100BASE-TX physical layer device component and the 1000BASE-KX physical layer device component to the backplane connector enables the communication card to support second communication cards that support either 100BASE-TX communication over the backplane, or 1000BASE-KX communication over the backplane.

The selected activation of one of the 100BASE-TX physical layer device component and the 1000BASE-KX physical layer device component on the communication card is based on a control signal. In various embodiments, this control signal can be generated based at least in part on either an auto-negotiation process or at least in part on a manual configuration process.

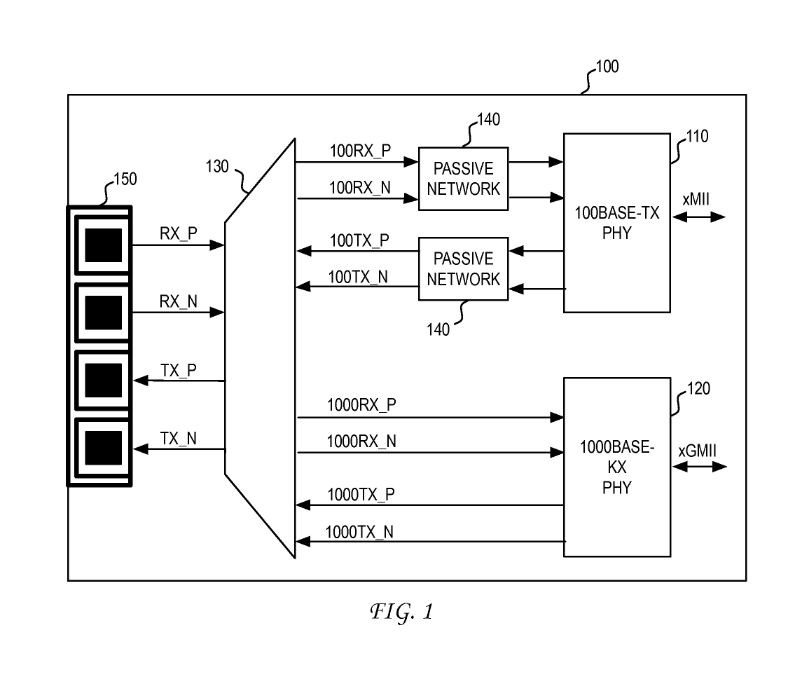

FIG. 1 illustrates an example embodiment of a backplane communication card that includes 100/1000 Ethernet support. 100 Mbit/s support is provided by 100BASE-TX physical layer device component 110, while 1 Gbit/s support is provided by 1000BASE-KX physical layer device component 120. As illustrated, 100BASE-TX physical layer device component 110 can be coupled to higher layers via an xMII interface, while 1000BASE-KX physical layer device component 120 can be coupled to higher layers via an xGMII interface.

The inclusion of 100BASE-TX physical layer device component 110 and 1000BASE-KX physical layer device component 120 onto a single backplane communication card provides flexibility in interfacing with other communication cards via the backplane. For example, where backplane communication card 110 is installed in a hub switch end, backplane communication card 100 can be designed to communicate with a remote communication card having a 100BASE-TX physical layer device component, or a remote communication card having a 1000BASE-KX physical layer device component. This increased functionality in backplane communication card 100 enables greater flexibility in supporting various generations of network infrastructure equipment.

As illustrated, backplane communication card 100 includes selection module 130 that is configured to selectively couple one of 100BASE-TX physical layer device component 110 and 1000BASE-KX physical layer device component 120 to connector 150. The selective connection enables backplane communication card to interoperate in either a 100 Mbit/s communication mode or a 1 Gbit/s communication mode depending on the capabilities of the remote communication card.

In one embodiment, 100BASE-TX physical layer device component 110 and 1000BASE-KX physical layer device component 120 can be implemented as separate chips on a backplane communication card. In another embodiment, 100BASE-TX physical layer device component 110 and 1000BASE-KX physical layer device component 120 are combined into a single multi-speed (100/1000) chip. Various levels of integration between 100BASE-TX physical layer device component 110 and 1000BASE-KX physical layer device component 120 can also be implemented without departing from the scope of the present invention.

As would be appreciated, 100BASE-TX physical layer device component 110 is designed for interfacing a network device with a twisted pair copper cabling interface, while 1000BASE-KX physical layer device component 120 is designed for interfacing a network device with a backplane interface. It is a feature of the present invention that a backplane communication card is provided that incorporates both a twisted pair physical layer device component as well as a backplane physical layer device component. As 100BASE-TX physical layer device component is designed for interfacing with a twisted-pair cabling interface using magnetics, the application of 100BASE-TX physical layer device component to a backplane interface is enabled through passive networks 140, which provide an interface without magnetics.

As noted above, the selective coupling of one of 100BASE-TX physical layer device component 110 and 1000BASE-KX physical layer device component 120 to connector 150 is performed using selection module 130. In one embodiment, selection module 130 is embodied as a multiplexer component. Here, it should be noted that the specific form in which selection module 130 is embodied is implementation dependent. In the example embodiment of FIG. 1, both 100BASE-TX physical layer device component 110 and 1000BASE-KX physical layer device component 120 can have almost no integration between them. As such, the signals produced by 100BASE-TX physical layer device component 110 and 1000BASE-KX physical layer device component 120 can represent the signals that are ready for transmission over the backplane interface. Similarly, the signals received from selection module can represent the signals that are received over the backplane interface.

In one embodiment, a higher level of integration of 100BASE-TX physical layer device component 110 and 1000BASE-KX physical layer device component 120 can be provided such that greater levels of sharing between the conversion components is provided. As would be appreciated, the extent to which 100BASE-TX physical layer device component 110 and 1000BASE-KX physical layer device component 120 are integrated can dictate the particular form in which selection module 130 is embodied. In general, selection module 130 can be embodied using one or more components that are designed to route backplane signals or signals derived from backplane signals for processing by a selected one of 100BASE-TX physical layer device component 110 and 1000BASE-KX physical layer device component 120, and/or to generate signals for transmission over a backplane or signals used to generate signals for transmission over a backplane.

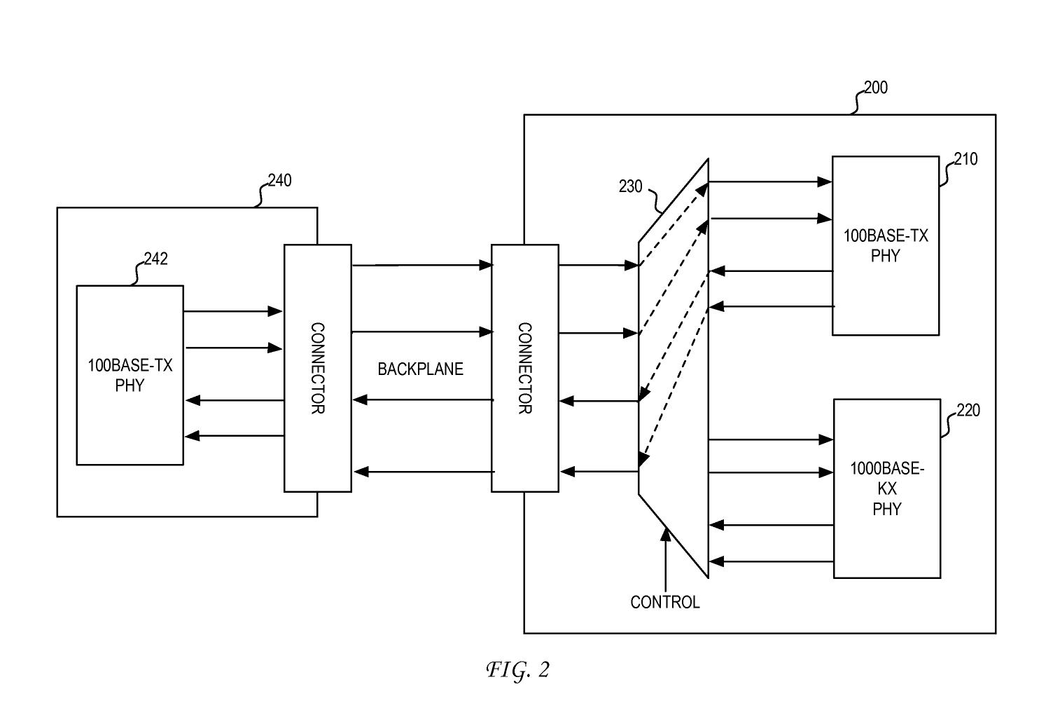

FIG. 2 illustrates an example of a 100/1000 backplane communication card communicating with a 100BASE-TX communication card over a backplane. As illustrated, backplane communication card 200 includes 100BASE-TX physical layer device component 210 and 1000BASE-KX physical layer device component 220. FIG. 2 includes a simplified illustration of components of backplane communication card 100 detailed in FIG. 1.

In the example scenario of FIG. 2, backplane communication card 200 is coupled to remote communication card 240 over a backplane. Remote communication card 240 includes 100BASE-TX physical layer device component 242. To facilitate communication between backplane communication card 200 and remote communication card 240, selector module 230 is configured to couple 100BASE-TX physical layer component 210 to the backplane connector of backplane communication card 200. This selective coupling is performed under the direction of a control signal received by selection module 230. In an embodiment where selection module 230 is embodied as a multiplexer, the control signal is used to configure the connection between inputs and outputs of the multiplexer.

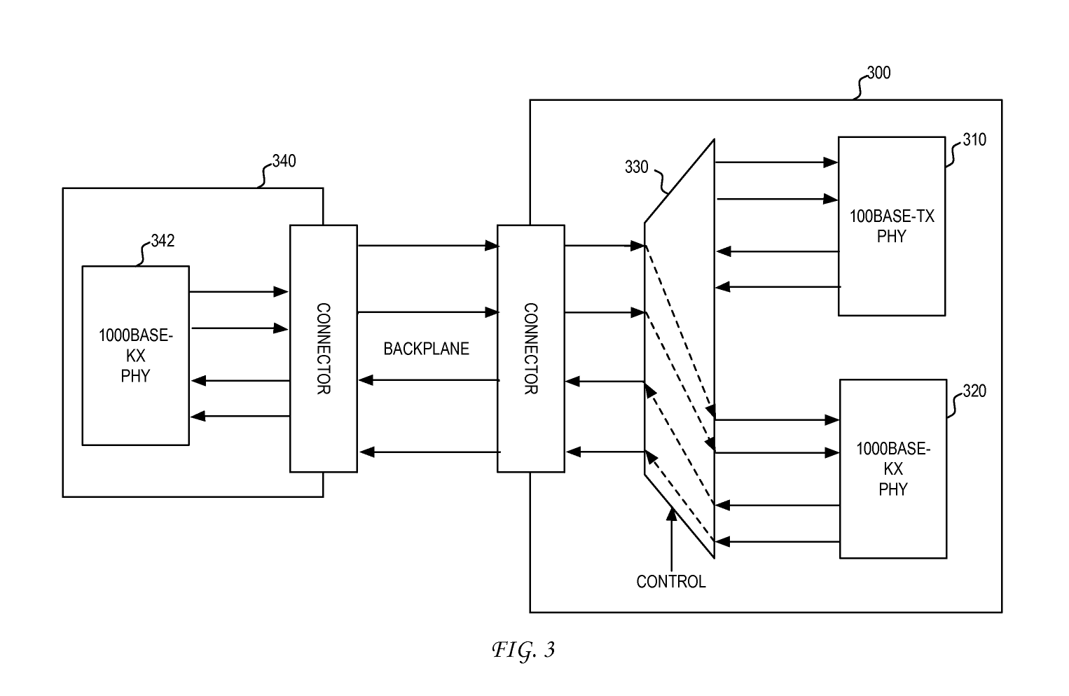

FIG. 3 illustrates a second example of a 100/1000 backplane communication card communicating with a 1000BASE-KX communication card over a backplane. As illustrated, backplane communication card 300 includes 100BASE-TX physical layer device component 310 and 1000BASE-KX physical layer device component 320. Again, FIG. 3 includes a simplified illustration of components of backplane communication card 100 detailed in FIG. 1.

In the example scenario of FIG. 3, backplane communication card 300 is coupled to remote communication card 340 over a backplane. Remote communication card 340 includes 1000BASE-KX physical layer device component 342. To facilitate communication between backplane communication card 300 and remote communication card 340, selector module 330 is configured to couple 1000BASE-KX physical layer component 320 to the backplane connector of backplane communication card 300. This selective coupling is performed under the direction of a control signal received by selection module 330. Again, in an embodiment where selection module 230 is embodied as a multiplexer, the control signal is used to configure the connection between inputs and outputs of the multiplexer.

As these two example scenarios illustrate, a 100/1000 backplane communication card can be flexibly applied in a network environment to ensure maximum compatibility with existing or newer cards in an enterprise network. Significant cost reductions are thereby realized as the value of previous investments in the infrastructure is retained.

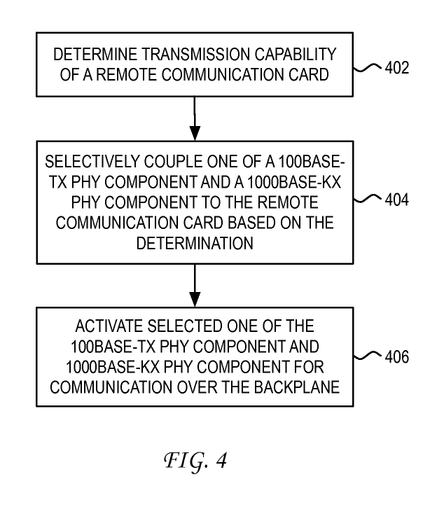

Having described a general hardware framework for implementing a 100/1000 backplane communication card, a description of a communication process according to the present inventions is now made with reference to the flowchart of FIG. 4. As illustrated, the process of FIG. 4 begins at step 402 where a determination of the transmission capability of a remote communication card is performed.

As would be appreciated, the specific mechanism by which the determination is made would be implementation dependent. In one embodiment, the determination is performed as part of a manual configuration process. Here, an IT administrator can manually determine the capabilities of the remote communication card and manually configure the mode used by the backplane communication card either locally or remotely using a remote management tool.

In another embodiment, the determination is performed as part of an auto-negotiation process. In one example, the auto-negotiation process can be defined to include a further designation of the 100BASE-TX operating mode to facilitate a capability exchange during the auto-negotiation process. Identification of a limitation of the remote communication card as supporting only a 100BASE-TX operating mode would lead the backplane communication card to selectively couple the 100BASE-TX physical layer device component to the backplane connector. In another embodiment, an automated process can be defined wherein a 100BASE-TX operating mode is selected where an auto-negotiation process does not select a 1000BASE-KX operating mode.

Regardless of the particular implementation-dependent mechanism that is used to determine the transmission capability of the remote communication card, such a determination enables selective coupling of one of the 100BASE-TX physical layer device component and 1000BASE-KX physical layer device component to the backplane connector at step 404. The selection module performs the selective coupling under the direction of a received control signal. As would be appreciated, the particular form of the control signal is dependent not only on the form of the selection component, but also on the mechanism by which the determination of step 402 is performed.

At step 406, the selected one of the 100BASE-TX physical layer device component and 1000BASE-KX physical layer device component is activated. As would be appreciated, the activation of the selected physical layer device component relative to the selective coupling is implementation dependent. In general, any sequence or combination of steps 402, 404 and 406 can be performed such that the end result of the process is a coupling of an activated physical layer device component that matches the capabilities of the remote communication card.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A communication card for use in a chassis, comprising:
a backplane connector that is configured to enable communication by said communication card over a backplane of said chassis;
a 100BASE-TX physical layer device component;
a 1000BASE-KX physical layer device component;
a selection module that is configured to selectively couple one of said 100BASE-TX physical layer device component and said 1000BASE-KX physical layer device component to said backplane connector, wherein said selective coupling enables a selected one of said 100BASE-TX physical layer device component and said 1000BASE-KX physical layer device component to communicate with a second communication card via said backplane of said chassis.

2. The communication card of claim 1, wherein said selection modules is a multiplexer.

3. The communication card of claim 1, wherein a selection of said 1000BASE-KX physical layer device component is responsive to an auto-negotiation process.

4. The communication card of claim 1, wherein a selection of said 100BASE-TX physical layer device component is responsive to a manual configuration process.

5. The communication card of claim 1, wherein said communication card facilitates an out-of-band control communication channel over said backplane.

6. A method, comprising:
determining, by a first communication card, a transmission capability of a second communication card that is coupled to said first communication card via a backplane in a chassis system, said first communication card including a 100BASE-TX physical layer device component and a 1000BASE-KX physical layer device component;
selectively coupling, by said first communication card based on said determination, one of said 100BASE-TX physical layer device component and said 1000BASE-KX physical layer device component to a backplane connector coupled to said backplane, wherein said selective coupling enables a selected one of said 100BASE-TX physical layer device component and said 1000BASE-KX physical layer device component to communicate with said second communication card via said backplane of said chassis; and
activating a selective one of said 100BASE-TX physical layer device component and said 1000BASE-KX physical layer device component to communicate with said second communication card via said backplane.

7. The method of claim 6, wherein said selectively coupling is based at least in part on an auto-negotiation process.

8. The method of claim 6, wherein said selectively coupling is based at least in part on a manual configuration process.

9. The method of claim 6, wherein communication between said first and second communication cards is an out-of-band control communication channel.

10. A communication card for use in a chassis, comprising:
a backplane connector that is configured to enable communication by said communication card over a backplane of said chassis;
a selection module that is configured to selectively couple one of a 100 Mbit/s physical layer device component and a 1 Gbit/s physical layer device component to said backplane connector, wherein said selective coupling enables a selected one of said 100 Mbit/s physical layer device component and said 1 Gbit/s physical layer device component to communicate with a second communication card via said backplane of said chassis.

11. The communication card of claim 10, wherein said 100 Mbit/s physical layer device component substantially conforms to IEEE 100BASE-TX.

12. The communication card of claim 10, wherein said 1 Gbit/s physical layer device component substantially conforms to IEEE 1000BASE-KX.

13. The communication card of claim 10, wherein said communication card facilitates an out-of-band control communication channel over said backplane.

14. The communication card of claim 10, wherein said selection module is responsive at least in part to an auto-negotiation process.

15. The communication card of claim 10, wherein said selection module is responsive at least in part to a manual configuration process.
